(19) United States
(12) Patent Application Publication
(10) Pub. No.: US 2020/0187041 A1
(43) Pub. Date: Jun. 11, 2020

(54) WIRELESS COMMUNICATION METHOD AND ASSOCIATED WIRELESS DEVICE

(71) Applicant: MEDIATEK INC., Hsin-Chu (TW)

(72) Inventors: Tsai-Yuan Hsu, Hsin-Chu (TW); Yi-Lun Chen, Hsin-Chu (TW); Chiao-Chih Chang, Hsin-Chu (TW)

(21) Appl. No.: 16/671,189

(22) Filed: Nov. 1, 2019

Related U.S. Application Data
(60) Provisional application No. 62/777,282, filed on Dec. 10, 2018.

(51) Int. Cl. H04W 28/02; H04W 28/10; H04W 76/15; H04W 80/02; H04L 5/00; H04L 1/18; H04W 72/08; H04L 29/06

(52) U.S. Cl. CPC H04W 28/0268; H04W 28/10; H04W 76/15; H04W 80/02; H04L 45/74; H04L 1/1809; H04W 72/085; H04L 65/80; H04L 5/0055

(57) ABSTRACT

The present invention provides a wireless communication method of a wireless device, wherein the wireless communication method includes the steps of: generating a first link-layer packet in a data link layer of the wireless device; using a first channel to transmit the first link-layer packet to an electronic device external to the wireless device; determining if a transmission of the first link-layer packet satisfies a condition; when the transmission of the first link-layer packet satisfies the condition, generating a second link-layer packet in the data link layer by duplicating data within the first link-layer packet; and using a second channel to transmit the second link-layer packet to the electronic device, and using the first channel to transmit the first link-layer packet again to the electronic device concurrently.

### CROSS REFERENCE TO RELATED APPLICATIONS

This application claims the priority of U.S. Provisional Application No. 62/777,282, filed on Dec. 10, 2018, which is included herein by reference in its entirety.

### BACKGROUND

In a real-time network application such as gaming and video streaming, traffic latency or jitter would affect a performance of this real-time application. Taking a portable electronic device as an example, the traffic latency comprises two parts, one is a latency derived from a radio access network (i.e. the latency between the portable device and an access point), and the other one is derived from an Internet Protocol (IP) network (i.e. latency between an Internet Service Provider (ISP)/Evolved Packet Core (EPC) and a server). The latency derived from the radio access network is easily influenced by an air condition or other packet loss issue, causing a worse performance of the real-time network application.

### SUMMARY

It is therefore an objective of the present invention to provide a wireless communication method, which can duplicate the link-layer packet when the transmission of the link-layer packet does not succeed, and use multiple channels to transmit the link-layer packet and the duplicated link-layer packet concurrently, to increase the packet robustness and against channel noises, to solve the above-mentioned problems.

According to one embodiment of the present invention, a wireless communication method of a wireless device is disclosed, wherein the wireless communication method comprises the steps of: generating a first link-layer packet in a data link layer of the wireless device; using a first channel to transmit the first link-layer packet to an electronic device external to the wireless device; determining if a transmission of the first link-layer packet satisfies a condition; when the transmission of the first link-layer packet satisfies the condition, generating a second link-layer packet in the data link layer by duplicating data within the first link-layer packet; and using a second channel to transmit the second link-layer packet to the electronic device, and using the first channel to transmit the first link-layer packet again to the electronic device concurrently.

According to another embodiment of the present invention, a wireless device comprising a circuitry is disclosed. The circuitry is configured to perform the steps of: generating a first link-layer packet in a data link layer of the wireless device; using a first channel to transmit the first link-layer packet to an electronic device external to the wireless device; determining if a transmission of the first link-layer packet satisfies a condition; when the transmission of the first link-layer packet satisfies the condition, generating a second link-layer packet in the data link layer by duplicating data within the first link-layer packet; and using a second channel to transmit the second link-layer packet to the electronic device, and using the first channel to transmit the first link-layer packet again to the electronic device concurrently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a communication system according to one embodiment of the present invention.

FIG. 2 shows the wireless device shown in FIG. 1 according to one embodiment of the present invention.

FIG. 3 shows a flowchart of a wireless communication method according to one embodiment of the present invention.

FIG. 4 shows a link-layer packet encapsulated with its IP tunnel.

FIG. 5 is a diagram illustrating the packet duplication according to one embodiment of the present invention.

FIG. 6 shows a communication system according to another embodiment of the present invention.

FIG. 7 shows the wireless device shown in FIG. 6 according to one embodiment of the present invention.

FIG. 8 shows a flowchart of a wireless communication method according to one embodiment of the present invention.

### DETAILED DESCRIPTION

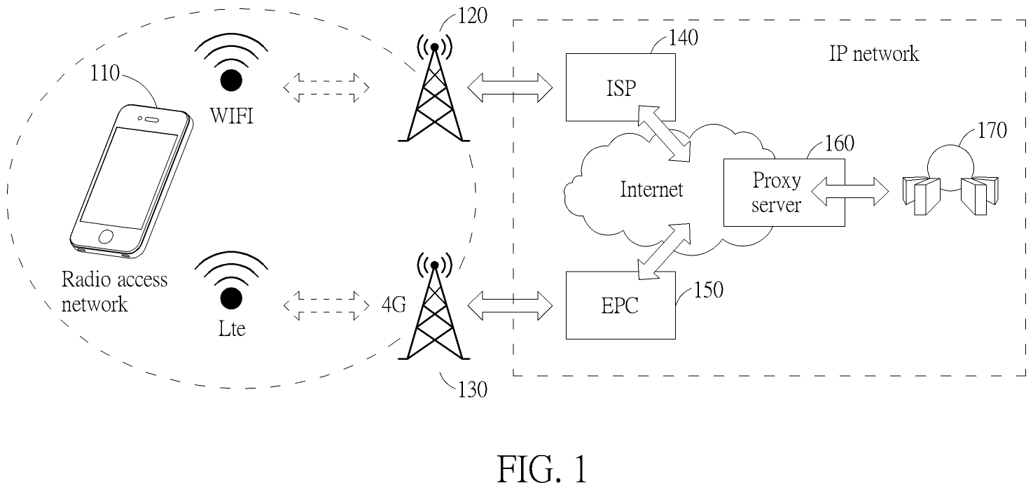

FIG. 1 shows a communication system according to one embodiment of the present invention. As shown in FIG. 1, a wireless device 110 comprises at least two network modules such as Wi-Fi module and a Long Term Evolution (LTE) module, and the wireless device 110 can use these Wi-Fi module and LTE module to communicate with a server 170 such as a gaming server. In detail, the wireless device 110 can use the Wi-Fi module to transmit packets to an access point 120, and these packets are transmitted to the server 170 via an ISP 140, Internet and a proxy server 160; and the wireless device 110 can use the LTE module to transmit packets to a base station 130, and these packets are transmitted to the server 170 via an EPC 150, Internet and the proxy server 160. The communications between the wireless device 110 and the access point 120 and the base station 130 are regarded as radio access network, and the communications between the server 170 and the ISP 140 and the EPC 150 are regarded as IP network. As described in the background, the latency derived from the radio access network is easily influenced by the air condition or other packet loss issue, causing a worse performance of the real-time network application. Therefore, the wireless device 110 provides a mechanism to duplicate the link-layer packet when the transmission of the link-layer packet does not succeed and satisfy one or more conditions, and use multiple channels (such as Wi-Fi channel and LTE channel) to transmit the link-layer packet and the duplicated link-layer packet simultaneously, to increase the packet robustness and become less susceptible to channel noises.

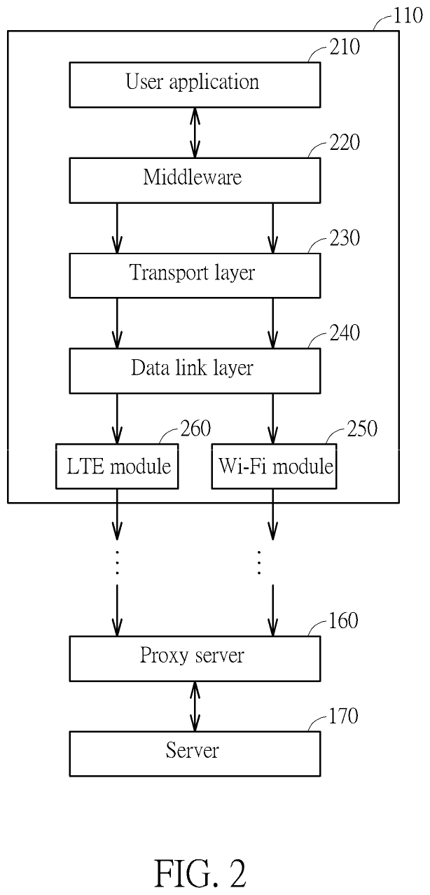

Specifically, FIG. 2 shows the wireless device 110 according to one embodiment of the present invention. As shown in FIG. 2, the wireless device 110 comprises a circuitry comprising an application micro-processor for executing operations of an user application 210, a middleware 220, a transport layer 230, a data link layer 240, and circuitry further comprises two network modules (in this embodiment, the Wi-Fi module 250 and the LTE module 260 serve as the network modules). The Wi-Fi module 250 and the LTE module 260 can be regarded as network interfaces of the wireless device 110.

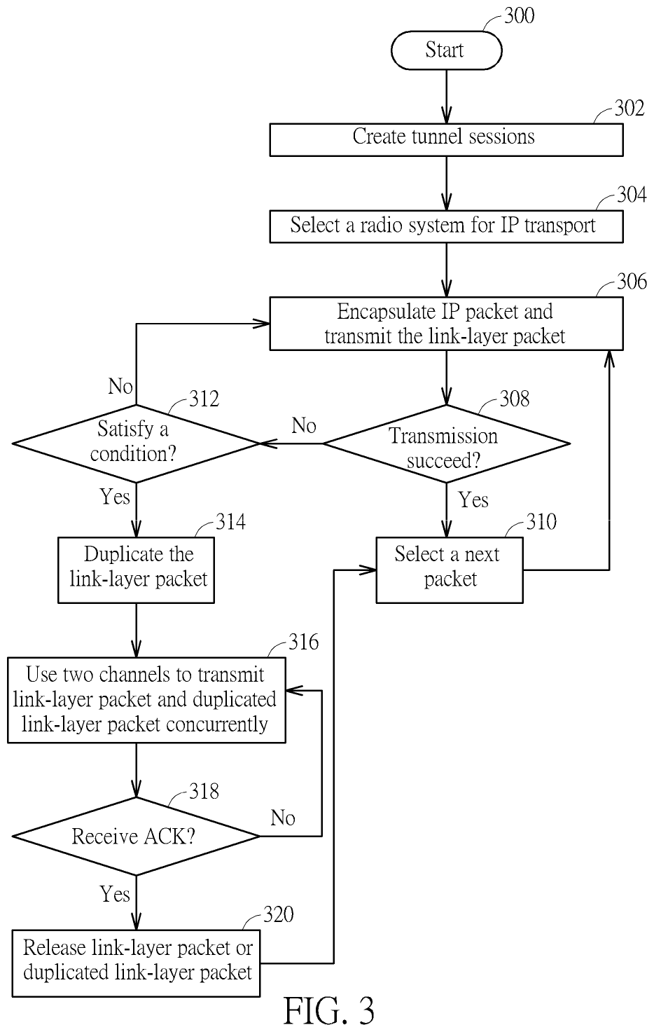

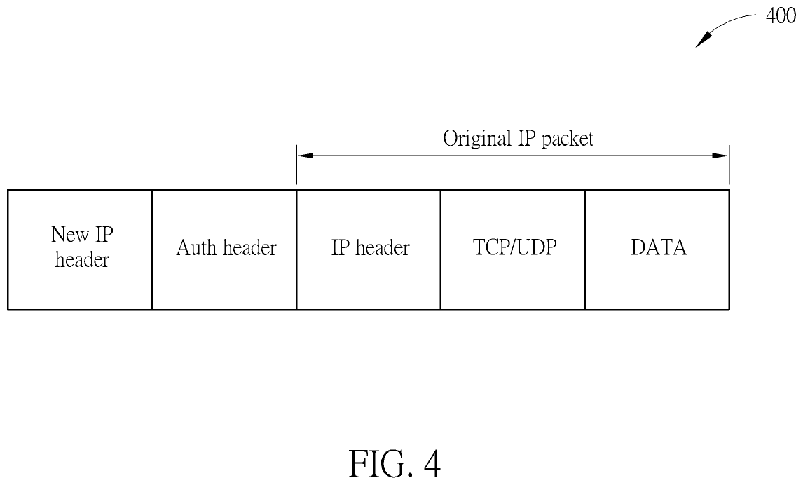

Refer to FIG. 2 and FIG. 3 together, where FIG. 3 shows a flowchart of a wireless communication method according to one embodiment of the present invention. In Step 300, the flow starts. In Step 302, the middleware 220 creates tunnel session via multiple network modules such as the Wi-Fi module 250 and the LTE module 260, that is the middleware 220 triggers tunnel establishment between each radio system (e.g., Wi-Fi system and LTE system) with individual IP address. In Step 304, the middleware 220 selects one of radio systems for IP transport based on a periodic quality such as received signal strength indication (RSSI), round-trip time (RTT) and/or packet drop rates. It is noted that the tunnel establishment in Step 302 and the transport layer selection in Step 304 are well known by a person skilled in the art, so the detailed descriptions are therefore omitted here. In Step 306, the data link layer 240 encapsulates the original IP packet with its IP tunnel to generate a link-layer packet, the selected network module is configured to transmit the link-layer packet to the server 170. In a link-layer packet 400 shown in FIG. 4, the original IP packet generated in the transport layer 230 comprises an IP header, a Transmission Control Protocol (TCP)/User Datagram Protocol (UDP) and a data portion, and the data link layer 240 encapsulates the original IP packet with a new IP header and the authentication header to generate the link-layer packet 400. When the Wi-Fi system is selected, the new IP header is corresponding to the IP address of the Wi-Fi system; and when the LTE system is selected, the new IP header is corresponding to the IP address of the LTE system.

In Step 308, the wireless device 110 determines if the link-layer packet is transmitted to the access point 120 or the base station 130. If the link-layer packet is successfully transmitted, the flow enters Step 310 to select a next packet; and if the link-layer packet is not successfully transmitted, the flow enters Step 312. In Step 312, the wireless device 110 determines if the transmission of the link-layer packet satisfies a condition or satisfies any one of a plurality of conditions, if yes, the flow enters Step 314; and if not (i.e. none of the plurality of conditions is satisfied), the flow enters Step 306 to re-transmit the link-layer packet. In this embodiment, the condition may be a determination result indicating if the re-transmission count of the link-layer packet is greater than a predetermined value, or a determination result indicating if a dwell time of the link-layer packet is greater than a predetermined value, or a determination result indicating if a privilege of a selected radio system (i.e. a selected channel/tunnel) is not granted due to the coexistence of other radio system(s) (e.g. the band is assigned to another radio system such as Bluetooth (BT) system); and the plurality of conditions may comprise the above-mentioned three conditions (i.e. re-transmission time, dwell time and privilege). In this embodiment, the dwell time represents the time that the link-layer packet dwells on the radio system without any chance to be transmitted; and “privilege” means that the radio system (e.g. Wi-Fi system) is granted to transmit signals, where this signal transmission will cause interference to other co-located radio system (e.g. BT system). In Step 314, the selected radio system notifies the other radio system, and the data link layer 240 generates a duplicated link-layer packet by duplicating data within the link-layer packet. In Step 316, the Wi-Fi channel/tunnel and the LET channel/tunnel are simultaneously used to transmit the link-layer packet and the duplicated link-layer packet, respectively. In Step 318, the wireless device 110 determines if one of the Wi-Fi module 250 and the LTE module 260 receives the ACK; and if none of the Wi-Fi module 250 and the LTE module 260 receives the ACK, the flow enters Step 316 to re-transmit the link-layer packet and the duplicated link-layer packet concurrently; and if one of the one of the Wi-Fi module 250 and the LTE module 260 receives the ACK, the flow enters Step 320. In Step 320, the network module receiving the ACK notifies the other network module to release the link-layer packet or the duplicated link-layer packet (i.e. discard the link-layer packet or the duplicated link-layer packet) and stop transmitting the link-layer packet or the duplicated link-layer packet. Then, the flow enters Step 310 to select the next packet.

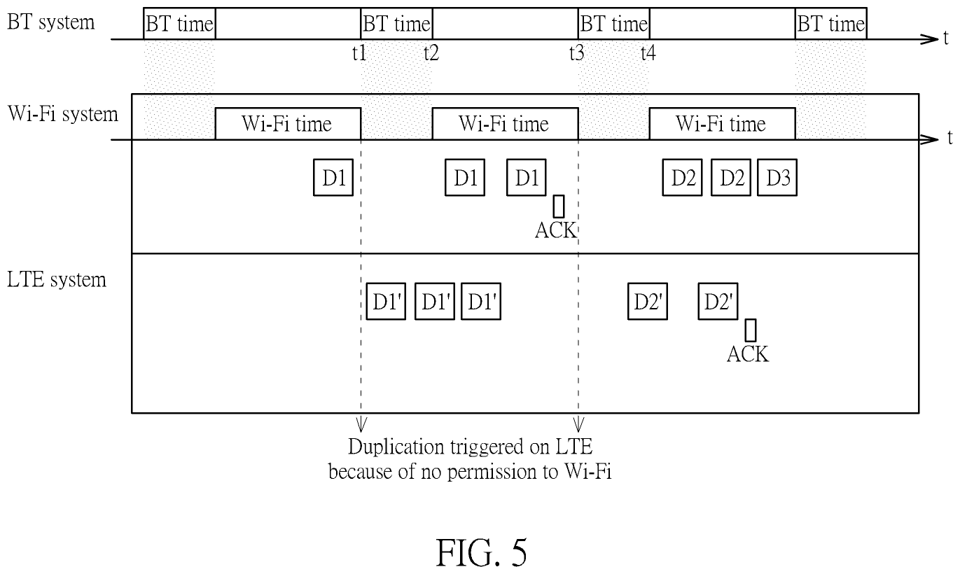

Regarding the Step 306-Step 320, taking FIG. 5 as example, it is assumed that the wireless device 110 further comprises the BT system, and because the Wi-Fi system and the BT system share the 2.4G band, the Wi-Fi system and the BT system operate in a time-division multiplexing (TDM) mode. In the embodiment shown in FIG. 5, it is assumed that initially the Wi-Fi system is selected, the data link layer 240 encapsulates the original IP packet with the new ID corresponding to the IP address of the Wi-Fi system to generate the link-layer packet D1, and the Wi-Fi module 250 starts to transmit the link-layer packet D1 to the access point 120. At time t1, the band is used by the BT system, and the Wi-Fi system is not allowed to transmit the link-layer packet D1 to the access point 120, so the data link layer 240 duplicates the link-layer packet D1 to generate a duplicated link-layer packet D1′, wherein the duplicated link-layer packet D1′ and the link-layer packet D1 have the same original IP packet shown in FIG. 4, but their new IP headers shown in FIG. 4 are different. Then, the LTE module 260 starts to transmit the duplicated link-layer packet D1′ to the base station 130. At time t2, the band is used by the Wi-Fi system, so the Wi-Fi module 250 uses the Wi-Fi tunnel/channel to transmit the link-layer packet D1, and the LTE module 260 uses the LTE tunnel/channel to transmit the duplicated link-layer packet D1′ concurrently. Then, if the Wi-Fi module 250 receives the ACK from the access point 120, it means that the link-layer packet D1 is successfully transmitted to the access point 120, the Wi-Fi module 250 notifies the LTE module 260 to release the duplicated link-layer packet D1′ temporarily stored in its buffer (i.e. the duplicated link-layer packet D1′ is discarded), and stop transmitting the duplicated link-layer packet D1′.

Then, at time t3, the data link layer 240 encapsulates the next IP packet with the new ID corresponding to the IP address of the Wi-Fi system to generate the link-layer packet D2, and the Wi-Fi module 250 prepares to transmit the link-layer packet D2 to the access point 120. Because the band is used by the BT system and the Wi-Fi system is not allowed to transmit the link-layer packet D2 to the access point 120, the data link layer 240 duplicates the link-layer packet D2 to generate a duplicated link-layer packet D2′, wherein the duplicated link-layer packet D2′ and the link-layer packet D2 have the same original IP packet shown in FIG. 4, but their new IP headers shown in FIG. 4 are different. Then, the LTE module 260 starts to transmit the duplicated link-layer packet D2′ to the base station 130. At time t4, the band is used by the Wi-Fi system, so the Wi-Fi module 250 uses the Wi-Fi tunnel/channel to transmit the link-layer packet D2, and the LTE module 260 uses the LTE tunnel/channel to transmit the duplicated link-layer packet D2′ concurrently. Then, if the LTE module 260 receives the ACK from the base station 130, it means that the duplicated link-layer packet D2′ is successfully transmitted to the base station 130, and the LTE 260 notifies the Wi-Fi module 250 to release the link-layer packet D2 temporarily stored in its buffer (i.e. discard the link-layer packet D2), and stop transmitting the link-layer packet D2.

In addition, the proxy server 160 may de-capsulate the received packet to obtain the original IP packet shown in FIG. 4, and forwards the original IP packet to the server 170. Furthermore, if both the link-layer packet and the duplicated link-layer packet are successfully transmitted, the proxy server 160 can detect and remove the duplicated one.

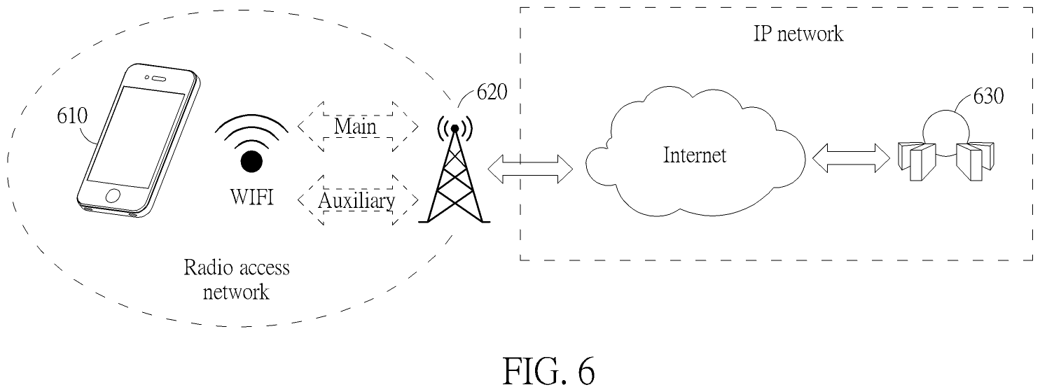

FIG. 6 shows a communication system according to another embodiment of the present invention. As shown in FIG. 6, a wireless device 610 comprises a Wi-Fi module supporting two channels corresponding to two bands, and the wireless device 610 can use these two channels to communicate with a server 630 such as a gaming server. In detail, the wireless device 610 may have a main channel and an auxiliary channel, and the wireless device 610 can use the main channel and the auxiliary channel to transmit packets to an access point 620. The communications between the wireless device 610 and the access point 620 are regarded as radio access network, and the communications between the server 630 and the access point 620 are regarded as IP network. As described in the background, the latency derived from the radio access network is easily influenced by the air condition or other packet loss issue, causing a worse performance of the real-time network application. Therefore, the wireless device 610 provides a mechanism to duplicate the link-layer packet when the transmission of the link-layer packet does not succeed and satisfy one or more conditions, and use the main channel and the auxiliary channel to transmit the link-layer packet and the duplicated link-layer packet concurrently, to increase the packet robustness and against channel noises.

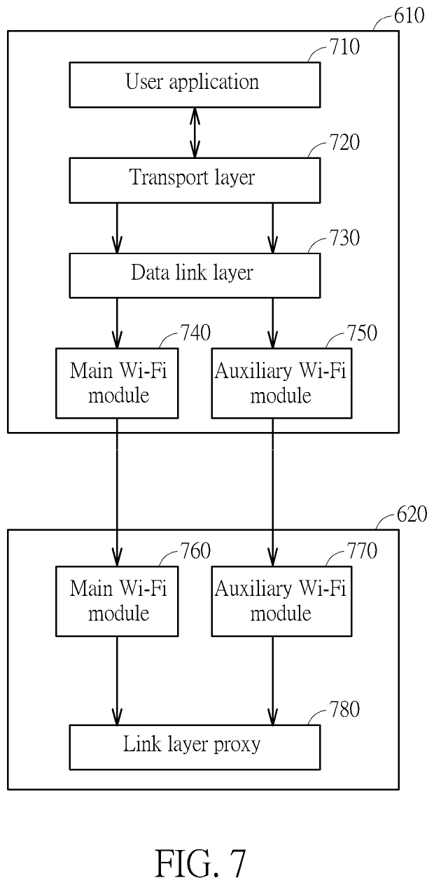

Specifically, FIG. 7 shows the wireless device 610 and the access point 620 according to one embodiment of the present invention. As shown in FIG. 7, the wireless device 610 comprises a circuitry comprising an application micro-processor configured to perform operations of an user application 710, a transport layer 720 and a data link layer 730, and the circuitry further comprises a main Wi-Fi module 740 and an auxiliary Wi-Fi module 750. In this embodiment, the main Wi-Fi module 740 and an auxiliary Wi-Fi module 750 can be regarded as a single network interface of the wireless device 610.

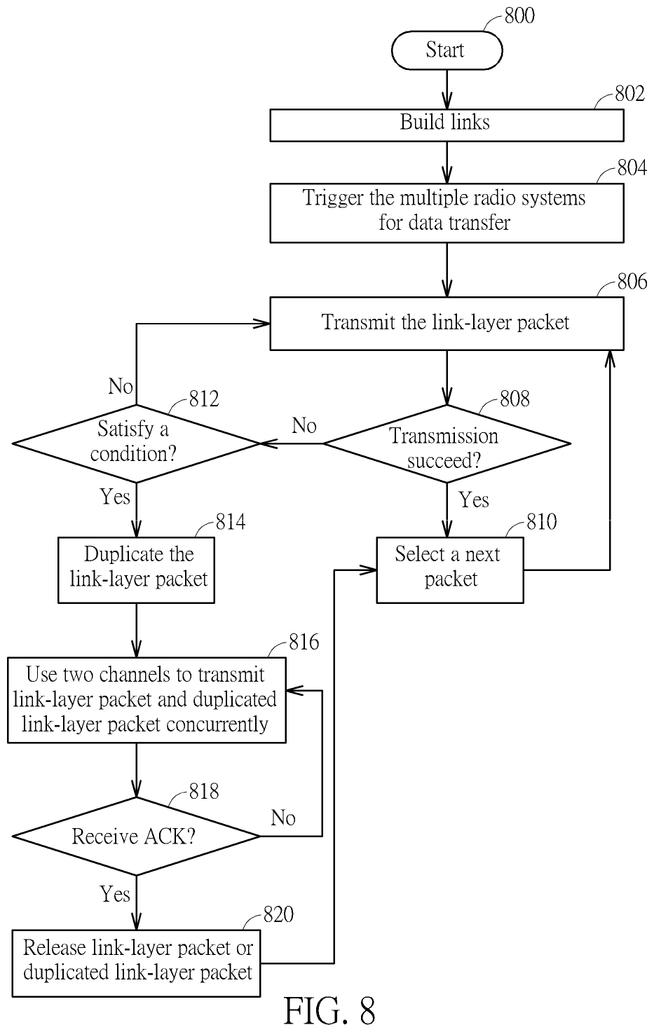

Refer to FIG. 7 and FIG. 8 together, where FIG. 8 shows a flowchart of a wireless communication method according to one embodiment of the present invention. In Step 800, the flow starts. In Step 802, the Wi-Fi system of the wireless device 610 builds a link with the access point 620, and information of the main Wi-Fi channel and the auxiliary Wi-Fi channel, such as Media Access Control (MAC) address, channel number, bandwidth etc., are obtained for data transfer. In Step 804, the main Wi-Fi module 740 triggers the multiple radio systems for data transfer. It is noted the operations of Step 802 and Step 804 are well known by a person skilled in the art, so further descriptions about the establishment of the main Wi-Fi channel and the auxiliary Wi-Fi channel are omitted here. In Step 806, the data link layer 730 generates a link-layer packet, and the main Wi-Fi module 740 is configured to transmit the link-layer packet to the server 630. In Step 708, the wireless device 610 determines if the link-layer packet is transmitted to the access point 620. If the link-layer packet is successfully transmitted, the flow enters Step 810 to select a next packet; and if the link-layer packet is not successfully transmitted, the flow enters Step 812. In Step 812, the wireless device 610 determines if the transmission of the link-layer packet satisfies a condition or satisfies any one of a plurality of conditions, if yes, the flow enters Step 814; and if not (i.e. none of the plurality of conditions is satisfied), the flow enters Step 806 to re-transmit the link-layer packet. In this embodiment, the condition may be a determination result indicating if the re-transmission count of the link-layer packet is greater than a predetermined value, or a determination result indicating if a dwell time of the link-layer packet is greater than a predetermined value, or a determination result indicating if a privilege of the main W-Fi channel is not granted due to the coexistence of other radio system(s) (e.g. the band of the main W-Fi channel is assigned to the BT system); and the plurality of conditions may comprise the above-mentioned three conditions (i.e. re-transmission time, dwell time and privilege). In Step 814, the main W-Fi module 740 notifies the auxiliary W-Fi module 750, and the data link layer 730 generates a duplicated link-layer packet by duplicating data within the link-layer packet. In Step 816, the main W-Fi module 740 uses the main Wi-Fi channel to transmit the link-layer packet, and the auxiliary W-Fi module 750 uses the auxiliary Wi-Fi channel to transmit the duplicated link-layer packet concurrently. In Step 818, the wireless device 610 determines if one of the main W-Fi module 740 and the auxiliary W-Fi module 750 receives the ACK; and if none of the main W-Fi module 740 and the auxiliary W-Fi module 750 receives the ACK, the flow enters Step 816 to re-transmit the link-layer packet and the duplicated link-layer packet concurrently; and if one of the main W-Fi module 740 and the auxiliary W-Fi module 750 receives the ACK, the flow enters Step 820. In Step 820, the network module receiving the ACK notifies the other network module to release/discard the link-layer packet or the duplicated link-layer packet and stop transmitting the link-layer packet or the duplicated link-layer packet. That is, if the main W-Fi module 740 receives the ACK from the access point 620, the main W-Fi module 740 notifies the auxiliary W-Fi module 750 to release/discard the duplicated link-layer packet and stop transmitting the duplicated link-layer packet; and if the auxiliary W-Fi module 750 receives the ACK from the access point 620, the auxiliary W-Fi module 750 notifies the main W-Fi module 740 to release/discard the link-layer packet and stop transmitting the link-layer packet. Then, the flow enters Step 810 to select the next packet.

In addition, the main Wi-Fi module 760 and the auxiliary Wi-Fi module 770 of the access point 620 are arranged to receive the link-layer packet and the duplicated link-layer packet, respectively. The link layer proxy 780 may de-capsulate the received packet and forwards decapsulated packet to the server 630. Furthermore, if both the link-layer packet and the duplicated link-layer packet are successfully transmitted, the link layer proxy 780 can detect and remove the duplicated one.

Briefly summarized, in the wireless communication method of the present invention, when the transmission of the link-layer packet does not succeed and satisfy a condition, the link-layer packet is duplicated, and the link-layer packet and the duplicated link-layer packet are transmitted by using different channels concurrently, to increase the packet robustness and against channel noises. In addition, because the packet duplication is performed in the data link layer, and the packet duplication is based on the per-packet detection, the packet duplication can be determined rapidly, and the latency of the radio access network can be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method of a wireless device, comprising:
generating a first link-layer packet in a data link layer of the wireless device;
using a first channel to transmit the first link-layer packet to an electronic device external to the wireless device;
determining if a transmission of the first link-layer packet satisfies a condition;
when the transmission of the first link-layer packet satisfies the condition, generating a second link-layer packet in the data link layer by duplicating data within the first link-layer packet; and
using a second channel to transmit the second link-layer packet to the electronic device, and using the first channel to transmit the first link-layer packet to the electronic device concurrently.

2. The wireless communication method of claim 1, wherein the first channel is established by using a first network module of the wireless device, the second channel is established by using a second network module of the wireless device, and the first network module and the second network module correspond to different Internet Protocol (IP) addresses.

3. The wireless communication method of claim 2, wherein the first network module is one of a Wi-Fi module and a Long Term Evolution (LTE) module, and the second network module is the other one of the Wi-Fi module and the LTE module.

4. The wireless communication method of claim 1, wherein both the first channel and the second channel are established by a network module within the wireless device having an IP address, and the first channel and the second channel correspond to different bands.

5. The wireless communication method of claim 4, wherein the network module is a Wi-Fi module.

6. The wireless communication method of claim 1, wherein the step of determining if the transmission of the first link-layer packet satisfies the condition comprises:
determining if a re-transmission count of the first link-layer packet is greater than a predetermined value; wherein if the transmission count of the first link-layer packet is greater than the predetermined value, the transmission of the first link-layer packet satisfies the condition.

7. The wireless communication method of claim 1, wherein the step of determining if the transmission of the first link-layer packet satisfies the condition comprises:
determining if a dwell time of the first link-layer packet is greater than a predetermined value; wherein if the dwell time of the first link-layer packet is greater than the predetermined value, the transmission of the first link-layer packet satisfies the condition.

8. The wireless communication method of claim 1, wherein the step of determining if the transmission of the first link-layer packet satisfies the condition comprises:
determining if a privilege of the first channel is not granted; wherein if the privilege of the first channel is not granted, the transmission of the first link-layer packet satisfies the condition.

9. The wireless communication method of claim 1, further comprising:
if receiving an acknowledgement (ACK) from the electronic device via the first channel, releasing the second link-layer packet and stopping transmitting the second link-layer packet to the electronic device via the second channel; and
if receiving the ACK from the electronic device via the second channel, releasing the first link-layer packet and stopping transmitting the first link-layer packet to the electronic device via the second channel.

10. A wireless device, comprising:
a circuitry configured to perform the steps of:
generating a first link-layer packet in a data link layer of the wireless device;
using a first channel to transmit the first link-layer packet to an electronic device external to the wireless device;
determining if a transmission of the first link-layer packet satisfies a condition;
when the transmission of the first link-layer packet satisfies the condition, generating a second link-layer packet in the data link layer by duplicating data within the first link-layer packet; and
using a second channel to transmit the second link-layer packet to the electronic device, and using the first channel to transmit the first link-layer packet again to the electronic device concurrently.

11. The wireless device of claim 10, wherein the first channel is built by using a first network module of the wireless device, the second channel is established by using a second network module of the wireless device, and the first network module and the second network module correspond to different Internet Protocol (IP) addresses.

12. The wireless device of claim 11, wherein the first network module is one of a Wi-Fi module and a Long Term Evolution (LTE) module, and the second network module is the other one of the Wi-Fi module and the LTE module.

13. The wireless device of claim 10, wherein both the first channel and the second channel are built by a network module within the wireless device having an IP address, and the first channel and the second channel correspond to different bands.

14. The wireless device of claim 13, wherein the network module is a Wi-Fi module.

15. The wireless device of claim 10, wherein the step of determining if the transmission of the first link-layer packet satisfies the condition comprises:
determining if a re-transmission count of the first link-layer packet is greater than a predetermined value; wherein if the transmission count of the first link-layer packet is greater than the predetermined value, the transmission of the first link-layer packet satisfies the condition.

16. The wireless device of claim 10, wherein the step of determining if the transmission of the first link-layer packet satisfies the condition comprises:
determining if a dwell time of the first link-layer packet is greater than predetermined value; wherein if the dwell time of the first link-layer packet is greater than the predetermined value, the transmission of the first link-layer packet satisfies the condition.

17. The wireless device of claim 10, wherein the step of determining if the transmission of the first link-layer packet satisfies the condition comprises:
determining if a privilege of the first channel is not granted; wherein if the privilege of the first channel is not granted, the transmission of the first link-layer packet satisfies the condition.

18. The wireless device of claim 10, further comprising:
if receiving an acknowledgement (ACK) from the electronic device via the first channel, releasing the second link-layer packet and stopping transmitting the second link-layer packet to the electronic device via the second channel; and
if receiving the ACK from the electronic device via the second channel, releasing the first link-layer packet and stopping transmitting the first link-layer packet to the electronic device via the second channel.
